(19) United States
(12) Patent Application Publication
(10) Pub. No.: US 2014/0053941 A1
(43) Pub. Date: Feb. 27, 2014

(54) PERISTALTIC PUMP HOSE

(71) Applicant: Edward Belcak, Atlanta, GA (US)

(72) Inventor: Edward Belcak, Atlanta, GA (US)

(21) Appl. No.: 13/994,298

(22) PCT Filed: Dec. 14, 2011
(86) PCT No.: PCT/US11/64899

§ 371 Date: Nov. 15, 2013

Related U.S. Application Data
(60) Provisional application No. 61/422,792, filed on Dec. 14, 2010.
(60) Provisional application No. 61/422,802, filed on Dec. 14, 2010.

(51) Int. Cl. F16L 11/08

(52) U.S. Cl. CPC F16L 11/085
USPC 138/125; 156/190

(57) ABSTRACT

A hose for a peristaltic pump is shown and described. The hose may include a generally tubular member capable of transporting a medium and a plurality of fabric layers positioned over the tubular member. The hose may further include a generally elastomeric outer layer positioned over the fabric layers, the outer layer having a generally smooth elastomeric outer surface.

### CROSS-REFERENCE TO RELATED APPLICATION

This application claims benefit from U.S. Provisional Patent Application No. 61/422,802 entitled “Peristaltic Pump Hose” filed on Dec. 14, 2010, and U.S. Provisional Patent Application No. 61/422,792 entitled “Hose for Peristaltic Pump” filed on Dec. 14, 2010, both of which are hereby incorporated in their entirety by reference.

### FIELD OF THE INVENTION

This application relates to a pump hose and more particularly to a pump hose capable of use in a peristaltic pump.

### BACKGROUND

Peristaltic hose pumps may be used at municipal and industrial sites wherever fluids are metered, dosed, or transferred from one place to another. Peristaltic pumps, moreover, may solve unique and complicated problems like handling bleach, corrosive and abrasive slurries, acids, alkali, colorants, inks and other difficult to pump solutions. These and other corrosive and aggressive materials, however, may limit the types of hoses that may be used with the peristaltic pump.

As the heart of every peristaltic pump is the hose, peristaltic pumps will often employ a mechanical design whose purpose is to promote long hose life. One factor that impacts the length of the hose life in a peristaltic pump is the sliding friction of multiple shoes. Since friction builds heat, and heat is detrimental to hose life, in order to promote longer hose life friction needs to be reduced.

The next impediment to long hose life is the number of occlusions or hose pinches required to pump. A peristaltic type hose pump with four rollers or shoes will pinch the hose four times per revolution of the shaft. A pump with two shoes or rollers will pinch it twice per revolution. Reducing the number of occlusions or hose pinches may help increase the life of the hose pump. Peristaltic pumps having multiple shoes can increase the number of occlusions or hose pinches. Therefore, to reduce this impact it is important to reduce the sliding friction between the shoe and hose.

Another factor impacting hose life is the amount of pressure present in the hose and peristaltic pump. In many industrial applications, the pressure is high enough to generally eliminate the ability for many materials to be used for the hose. Additionally, the pressures being sustained over a period of time may also lead to deterioration of the hose, further limiting the life of the hose and peristaltic pump. Unlike like the peristaltic pump hoses used for medical use, which does not use reinforced hoses, a peristaltic pump hose for industrial uses must be able to sustain these much higher pressures to function properly.

Moreover, in the prior art, the outer surface of the pump may include a material such as metal to provide the generally smooth surface. In these prior art hoses, the metal outer surface may be required to be machined in an effort to generally reduce the friction present in this prior art version. This machining may add heat to the hose, which may lead to premature wear of the hose. Additionally, the machining of the hose may require additional lead time to produce the hose, which may otherwise generally increase the cost to produce.

There is a need, therefore for a hose of a peristaltic pump capable of sustaining the great pressures on it while in use, especially for industrial use. Additionally, there is a need for a peristaltic pump that may reduce the friction created during operation while requiring less processing. Finally, there is a need for a hose of a peristaltic pump that may handle aggressive materials, especially when used in industrial applications.

### SUMMARY

A hose for a peristaltic pump is shown and described. The hose may include a generally tubular member capable of transporting a medium and a plurality of fabric layers positioned over the tubular member. The hose may further include a generally elastomeric outer layer positioned over the fabric layers, the outer layer having a generally smooth elastomeric outer surface.

An elastically deformable hose for a peristaltic pump may include a generally tubular member capable of transporting a medium, the tubular member formed from a group consisting of: ultra high molecular weight polyethylene, fluoropolymer elastomer, polychloroprene and nitrile butadiene rubber. The hose may further include a plurality of fabric layers generally positioned over the tubular member and an ethylene propylene diene monomer rubber outer layer generally positioned over the fabric layers.

A hose for a peristaltic pump for industrial use may include an elastically deformable generally tubular member capable of transporting a medium and a plurality of fabric layers positioned over the tubular member. The hose may also include a generally elastomeric outer layer positioned over the fabric layers, the elastomeric layer including a generally smooth outer surface, where the outer surface is formed by wrapping the elastomeric layer with a plastic film, autoclaving the tubular member, fabric layers, elastomeric outer layer, and plastic film combination, and removing the plastic film.

A method of forming a hose for a peristaltic pump may include forming a generally tubular member capable of transporting a medium, placing a plurality of fabric layers over the tubular member, and positioning an elastomeric outer layer generally over the fabric layers. The method may further include wrapping the elastomeric outer layer with a film of at least one of plastic and polyester, and vulcanizing the tubular member, fabric layers elastomeric outer layer, and film combination.

A method of forming a hose for a peristaltic pump may include forming a generally tubular member including a material selected from a group consisting of: fluoropolymer elastomer, polychloroprene, nitrile butadiene rubber, and ultra high molecular weight polyethylene, where the tubular member is capable of transporting a medium. The method may further include placing a plurality of fabric layers over the tubular member, positioning an ethylene propylene diene monomer rubber outer layer generally over the fabric layers, and forming a generally smooth outer surface on the outer layer using a plastic film.

A method of forming a hose for a peristaltic pump may include forming a generally tubular member formed from a group consisting of: fluoropolymer elastomer, polychloroprene, nitrile butadiene rubber, and ultra high molecular weight polyethylene, wherein the tubular member is capable of transporting a medium. The method may further include placing a plurality of fabric layers over the tubular member, positioning an ethylene propylene diene monomer rubber outer layer over the fabric layers, wrapping the outer layer with a Mylar film, vulcanizing the tubular member, fabric layers elastomeric outer layer, and Mylar film combination, and removing the Mylar film from the tubular member, fabric layers, and elastomeric outer layer combination.

### BRIEF DESCRIPTION OF THE DRAWINGS

Operation of the invention may be better understood by reference to the detailed description taken in connection with the following illustrations, wherein:

FIG. 1 is a perspective partially exploded view of a peristaltic pump.

FIG. 2 is a perspective view of some embodiments of a hose of a peristaltic pump, partially exploded.

FIG. 3 is a cross-sectional view of the hose of FIG. 2.

FIG. 4 is a perspective view of other embodiments of a hose of a peristaltic pump, partially exploded.

FIG. 5 is a cross-sectional view of the hose of FIG. 4.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

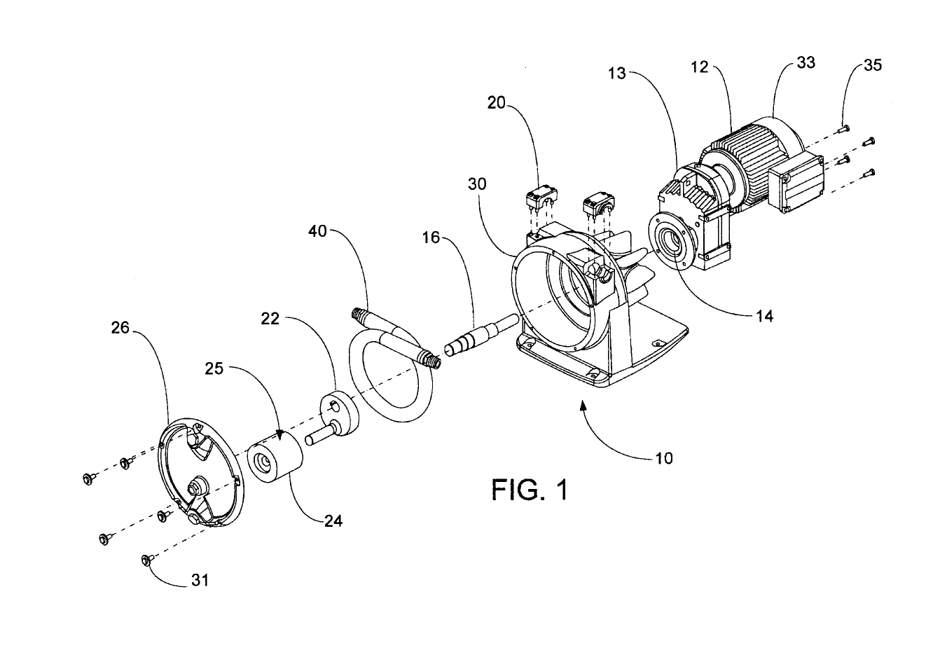

An exemplary embodiment of a peristaltic pump 10 is shown in FIG. 1. In some embodiments, the peristaltic pump 10 may include a motor 12, a gearbox 13, a drive train 14, an independent shaft 16, a hose clamp assembly 20, an eccentric shaft 22 with roller/shoe 24, a cover 26, a housing 30, and a hose 40. While the peristaltic pump 10 is shown and described with these features and elements, the present teachings are not limited to the construction shown and described. Additional elements may be added or elements removed without departing from the present teachings.

In some embodiments, the housing 30 may be a single-piece integral housing that may be formed through any appropriate process, such as by way of a non-limiting example, casting, forging, machining or the like. In other embodiments, the housing 30 may be a multi-piece housing—it may be formed of components secured together such as by welding, fastening, adhering or the like. The cover 26 may be removably connected to the housing 30 to generally permit access to the interior components of the peristaltic pump 10. The cover 26 may be attached to the housing 30 in any appropriate manner, such as by means of a plurality of fasteners 31, such as a nut and bolt combination shown in FIG. 1, welding, adhering or a combination of such.

The motor 12 may include a motor housing 33 that may generally encapsulate the motor 12 and may generally protect the motor 12 from environmental intrusions. The motor housing 33 likewise may removably attach to the housing 30 using fasteners 35 such as the nut and bolt combination shown. Although, it should be understood that alternative embodiments may use other means such as welding, adhesives, or the like or where the one-piece housing 30 may also include a compartment for the motor 12, such that the motor housing 30 may be formed with the housing 30.

The motor 12 may be operatively coupled to one end of the drive train 14 through the gear box 13. The drive train 14 may be integrally formed or may be formed from multiple pieces operatively coupled together. The drive train 14, at a second end, may be operatively coupled to the shaft 16. In some embodiments, the shaft 16 may be an independent shaft or in other embodiments, the shaft 16 may be formed with the drive train 14. The shaft 16 may be operatively coupled to the eccentric shaft 22.

In these embodiments, therefore, the motor 12 may rotate the drive train 14, which in turn may rotate the shaft 16. This may result in rotation of the eccentric shaft 22. The rotation of the eccentric shaft 22 may operatively push the roller/shoe 24 against the hose 40. The roller/shoe 24 may push the liquid or other medium in the hose 40 through the pump 10 in any appropriate manner.

The hose 40 may attach to the pump 10 in any appropriate manner. By way of a non-limiting example, the hose 40 may be operatively attached to the pump 10 through use of the hose clamp assembly 20. In these embodiments, the hose clamp assembly 20 may include an appropriate quick connect mechanism, such as by way of a non-limiting example, the ends of the hose 40 may operatively connect with the quick connect mechanism of the hose clamp assembly 20 holding the hose 40 in an appropriate position for operation of the pump 10. Alternatively, one end of the hose 40 may operatively connect with the quick connect mechanism of the hose clamp assembly 20, or the other end of the hose 40 may operatively connect with the quick connect mechanism of the hose clamp assembly 20. The quick connect mechanism of the hose clamp assembly 20 may aid in removing the hose 40 from the pump 10—making it easier for the operator to disconnect the hose 40 from the pump 10 for any reason. The quick connect mechanism of the hose clamp assembly 20 may, therefore, allow the hose 40 to be selectively attachable and detachable from the pump 10 as appropriate.

The roller/shoe 24 in some embodiments may be a single oversized roller/shoe that may be capable of appropriately compressing the hose 40 during operation of the pump 10. In some embodiments, the roller/shoe 24 may compress the hose 40 through more than 360 degrees of rotation. The roller/shoe 24 may be a large roller/shoe that has a generally cylindrical body that may operatively attach to the eccentric shaft 22. The roller/shoe 24 may include an outer surface 25 that may be generally concentric and smooth, which may generally reduce friction that may be present during operation of the pump 10. Additionally, in some embodiments, the hose may be a low-friction hose, as described in more detail below. The combination of the oversized roller/shoe 24 and low friction-hose 40 may generally help to reduce the sliding friction that may otherwise be present. Moreover, the large diameter roller/shoe 24 may provide a long sealing line during operation so that the peristaltic pump 10 may generally build pressure without backflow.

In those embodiments in which the pump 10 includes only one roller/shoe 24, the hose 40 may only be compressed once per revolution. In particular, as the roller/shoe 24 may be mounted on the eccentric shaft 22, the roller/shoe 24 may, therefore, rotate in an eccentric motion instead of concentric motion. This eccentric motion may allow for the use of only one roller/shoe and may thus further result in the hose 40 being compressed only once per revolution. This may reduce the amount of occlusions/pinching of the hose 40. Further, this eccentric motion of the roller/shoe 24 may allow a concentric roller/shoe to be utilized, which may reduce the friction that may otherwise be present during operation of the pump 10. This may extend the life of the hose 40.

In some embodiments of the pump 10, a small reservoir of lubricant, such as by way of a non-limiting example, synthetic DST™ lubricant (not shown) may be used. In these embodiments, the lubricant may further reduce friction between the roller/shoe 24 and the hose 40 while efficiently dissipating heat away from the process. The DST lubricant may assist with extending the life of the hose 40.

Since peristaltic type hose pumps come in different shapes and sizes, the industry has introduced the P/100 ratio to make a fair and equal comparison of one pump to another. The P/100 ratio is the number of hose pinches required to displace 100 gallons of fluid. The present embodiment of the pump 10 may result in a generally low P/100 ratio, which may result in the pump 10 being generally more efficient than other prior art pumps.

These embodiments of the pump 10 may result in, among other things, more flow per revolution and just one compression and expansion per cycle than other prior art pumps. In addition, the hose 40 diameter may differ within the same housing 30, which may enhance operational flexibility and expand the pump's 10 application possibilities. The pump 10 may also include, but are not limited to, a buffer zone (not shown) between the pump 10 and gearbox 13 that may generally protect the drive and bearings, a compact integral drive and motor, DST™ synthetic lubricant that may extend hose life, and a wider range of operating speeds. It should be understood, however, that the present teachings are not limited to the aforementioned and that in some embodiments the pump 10 may include all of the aforementioned; in other embodiments, the pump 10 may include at least one of the aforementioned; and in yet other embodiments, the pump 10 may include any combination of the aforementioned.

In some embodiments, the pump 10 and hose 40 may have positive displacement. In these embodiments, the pump 10 and hose 40 may be capable of operating in either direction without flow variation. In addition, the pump 10 and hose 40 may be capable of running dry without damage to pump 10 or hose 40, may be capable of pulling 95% of full vacuum, and may have a repeatability of about +/−1% accuracy.

In other embodiments, the peristaltic pump 10 may include a valveless or glandless design having no dynamic seals in contact with the pumped product, liquid or medium. In addition other embodiments of the peristaltic pump 10 may include a direct coupled gear drive arrangement. The present teachings are not limited to the peristaltic pump 10 shown and described herein. The present teachings may apply to any appropriate peristaltic pump.

The heart of every peristaltic pump is the hose. In some embodiments, the hose 40 may be generally elastically deformable. The hose 40 of some embodiments may include a fabric reinforced, rubber elastomeric tube that may be capable of a reasonably high pressure rating. This may be differentiated from prior art peristaltic pumps that may include an extruded tubing; especially those used in a chemistry laboratory or a hospital. Unlike the prior art peristaltic pumps, these embodiment of the hose 40 may be capable of industrial use. For peristaltic hose pumps used for industrial purposes the hose may need to withstand high pressures. Thus the hose 40 may need to be able to sustain these higher pressures, which pumps used for medical purposes or in laboratories may not be capable of handling. In addition, the hose 40, which may be used for industrial purposes, may need to be able to handle fluids that are aggressive, abrasive and/or contain solvents, such as, but not limited to, bleach, slurries, acids, alkali, colorants, inks, biofuels and shotcrete. A hose that may only include generally extruded tubing may not be capable of handling such materials.

In some embodiments of the peristaltic hose pump 10 the hose 40 may include at least three layers: an extruded inner wetted layer 41 compatible with the process fluid or medium, an appropriate number of layers of fabric reinforcement 42 and an elastomeric outer layer 43. The outside diameter of the hose 40 may maintain a wall thickness within about +/−0.5 mm tolerance. The minimum static burst pressure rating of the hose 40 of these embodiments may be about 800 psi. However, these are merely exemplary measurements and the hose 40 is not limited to such measurements.

In some embodiments the elastomeric outer layer 43 of the hose 40 may be comprised of natural rubber, styrene butadiene rubber (“SBR”), or a combination of such with about 60+/−5 Durometer. In other embodiments the elastomeric outer layer 43 may be comprised of ethylene propylene diene monomer (“EPDM”) or any other similar material. The elastomeric outer layer 43 may be any color, but in some embodiments the elastomeric outer layer may be generally black.

In some embodiments the inner layer 41 of the hose 40 may be comprised of ultra high molecular weight polyethylene (“UHMW-PE”). In other embodiments, the inner layer 41 of the hose 40 may be comprised of any appropriate material. By way of a non-limiting example, the inner layer 41 of the hose may include at least one of: UHMW-PE, EPDM, Viton™ (fluoropolymer elastomer), Neoprene (polychloroprene) or nitrile butadiene rubber. In other embodiments, the inner layer 41 may be of any appropriate combination of such materials.

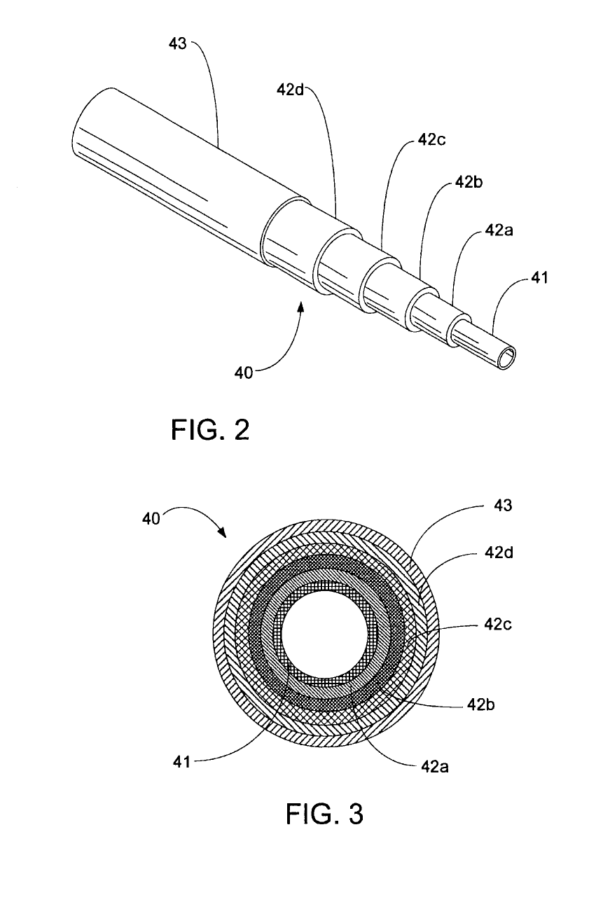

In some embodiments the fabric reinforcement 42 may be generally positioned between the inner layer 41 of the hose 40 and the elastomeric outer layer 43 of the hose 40. The fabric reinforcement 42 may be comprised of materials such as, but not limited to, a four-ply polyester insert. In these embodiments, the four-ply polyester insert may include four distinct layers of polyester that may each be wrapped over the inner layer 41. The fabric reinforcement 42 may generally add strength to the hose 40 and may help the hose 40 handle the large pressures present in the industrial applications of the pump 10. As shown in FIGS. 2 and 3, the four-ply polyester insert is shown as 42a, 42b, 42c, and 42d.

The hose 40 may be formed by forming the inner layer 41 from the appropriate material, such as by way of a non-limiting example, at least one of UHMW-PE, EPDM, Viton, Neoprene, nitrile butadiene rubber, or any combination of such. The first layer of the four-ply fabric reinforcement 42a may be wrapped around the inner layer 41. Each subsequent layer of fabric reinforcement, e.g., 42b, 42c, and 42d, may be wrapped around each other layer of fabric reinforcement until the appropriate number of layers has been added. The elastomeric outer layer 43, which may be EPDM, may then be wrapped over the last layer of the fabric reinforcement, e.g., 42d. The assembled combination may then be placed in an autoclave and vulcanized forming the hose 40. In some embodiments, fabric (not shown) may be tightly wound around the hose 40 before vulcanizing. Once the hose 40 has been vulcanized, the fabric wrap may then be removed.

The pump 10 and hose 40 of the embodiments herein may be used at municipal and industrial sites or wherever materials and fluids are metered or moved from one place to another. The pump 10 may be able to handle abrasive and difficult-to-pump fluids such as, but not limited to, bleach, slurries, acids, alkali, colorants, inks, biofuels and shotcrete.

Additional embodiments of a peristaltic pump and pump hose according the present teachings are described below. In the descriptions, all of the details and components may not be fully described or shown. Rather, the features or components are described and, in some instances, differences with the above-described embodiments may be pointed out. Moreover, it should be appreciated that these additional embodiments may include elements or components utilized in the above-described embodiments although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired peristaltic pump and pump hose without departing from the spirit and scope of the present teachings.

In other embodiments, the hose 140 may include at least three layers: an extruded inner wetted layer 141 compatible with the process fluid or medium, an appropriate number of layers of fabric reinforcement 142, and an elastomeric outer layer 143 that may include a generally smooth outer surface 145 that may generally void of protuberances. In some embodiments the inner layer 141 of the hose 140 may be comprised of Ultra High Molecular Weight Polyethylene (“UHMW-PE”). In other embodiments, the inner layer 141 of the hose 140 may be comprised of any appropriate material. By way of a non-limiting example, the inner layer 141 of the hose may include at least one of: UHMW-PE, EPDM, Viton™ (fluoropolymer elastomer), Neoprene (polychloroprene) or nitrile butadiene rubber. In other embodiments, the inner layer 141 may be of any appropriate combination of such materials.

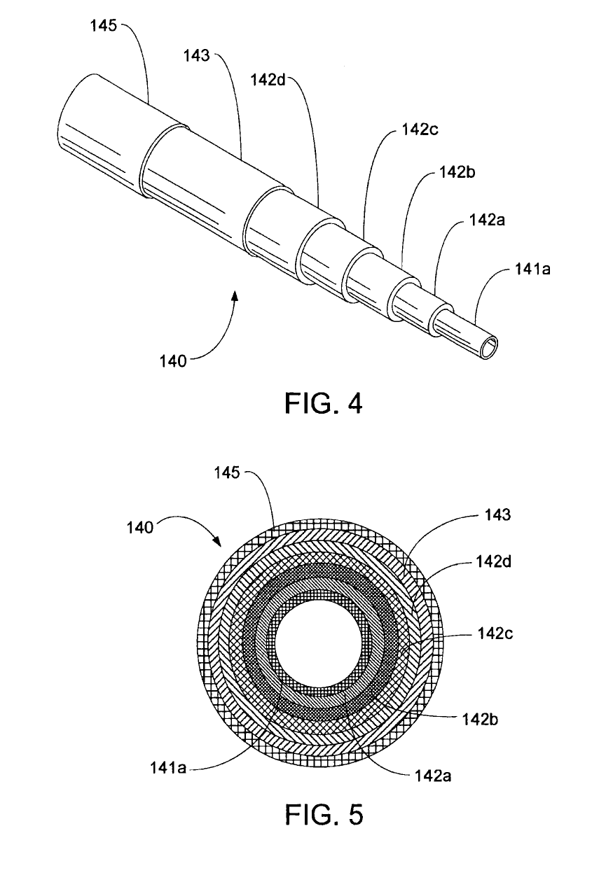

In some embodiments the fabric reinforcement 142 may be generally positioned between the inner layer 141 of the hose 140 and the elastomeric outer layer 143 of the hose 140. The fabric reinforcement 142 may be comprised of materials such as, but not limited to, a four-ply polyester insert. In these embodiments, the four-ply polyester insert may include four distinct layers of polyester that may each be wrapped over the inner layer 141, shown as 142a, 142b, 142c, and 142d in FIGS. 4 and 5. The fabric reinforcement 142 may generally add strength to the hose 140 and may help the hose 140 handle the large pressures present in the industrial applications of the pump 10 and hose 140.

In some embodiments the elastomeric outer layer 143 of the hose 140 may be comprised of Natural Rubber/SBR. In other embodiments the elastomeric outer layer 143 may be comprised of EPDM or any other appropriate material. In these embodiments, the elastomeric outer layer 143 may include the outer surface 145 that may be generally smooth and may generally void of protuberances. In these embodiments, the outer surface 145 of the hose 140 may utilize a generally smooth surface finish to attempt to reduce presence of friction in the pump 10, which may result in the low friction hose as noted above. In particular, the roller/shoe 24 compressing the hose 140 during rotation of the roller/shoe 24 and eccentric shaft 22 may create friction. The outer surface 145 of the hose 140 being generally smooth and void of protuberances may provide a surface with a generally lower coefficient of friction that may generally reduce the friction that may otherwise occur between the roller/shoe 24 and the hose 140 during operation of the pump 10.

In these embodiments, the generally smooth outer surface 145 of the hose 140 may be formed by including a film of any appropriate material, such as a plastic or polyester film, being placed over the hose 140 to generally encompass the hose 140 and then processed to create the generally smooth outer surface 145. By way of a non-limiting example, a Mylar® film may be placed over the hose 140 generally encompassing the hose 140. The Mylar film may be tightly wrapped around the outer diameter of the hose 140, or more specifically wrapped around the outer surface 143 of the hose 140. The hose 140 may then be vulcanized. In particular, the outer layer 143 of the hose 140 may be vulcanized with the Mylar film tightly wrapped there around. Once the hose 140 has been vulcanized, the Mylar film may be removed therefrom, which may result in the generally smooth outer surface 145. In these embodiments, the Mylar film may create a generally smooth outer surface 145 on the outer layer 143.

More specifically, the hose 140 may be assembled by taking the extruded inner layer 141 and then wrapping the fabric reinforcement 142 over the inner layer 141—this may be repeated until the appropriate number of fabric reinforcement layers 142 are wrapped around the inner layer 141, e.g., four such layers may be used, 142a, 142b, 142c, and 142d. The elastomeric outer layer 143 may then be positioned over the fabric reinforcement layers 142a, 142b, 143c, and 142d. The outer layer 143 may be of a material that may be vulcanized to create a generally strong finish. In these embodiments, the Mylar film may placed over the assembled hose 140, i.e., immediately over the outer layer 143.

The assembled hose 140 with the Mylar finish may then be placed in an autoclave to vulcanize the outer layer 143. Once the hose 140 has been vulcanized, the Mylar film may be removed and this may result in the hose 140 having the generally smooth outer surface 145. Because the Mylar film has a smooth finish it may create a generally smooth finish for the outer surface 145 of the outer layer 143. The finish of the outer surface 145 may be such that it does not need to be machined further to create the adequately smooth surface, which may reduce the friction present during operation of the pump 10. In some embodiments, a fabric may be wrapped around the inner layer 141, the fabric reinforcement layers 142a, 142b, 142c, and 142d and the outer layer 143 before vulcanizing. In these embodiments, the Mylar film may be wrapped over the fabric and then the combination may be vulcanized in the autoclave, which may create the generally smooth outer surface 145.

The hose 140 of these embodiments may be used with pumps that may require the reduction of friction by having a tube that includes a generally smooth outer surface. The hose 140 may not require any additional machining to be used in these pumps whereas the prior art hoses require this additional machining step.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A hose for a peristaltic pump, the hose comprising:
a generally tubular member capable of transporting a medium;
a plurality of fabric layers positioned over the tubular member; and
a generally elastomeric outer layer positioned over the fabric layers, the outer layer having a generally smooth elastomeric outer surface.

2. The hose of claim 1, wherein the generally tubular member is formed from a generally plastic material.

3. The hose of claim 2, wherein the plastic material is ultra high molecular weight polyethylene.

4. The hose of claim 1, wherein the generally tubular member is formed from a generally rubber material.

5. The hose of claim 4, wherein the rubber material is selected from a group consisting of: fluoropolymer elastomer, polychloroprene and nitrile butadiene rubber.

6. The hose of claim 4, wherein the rubber material is a fluoropolymer elastomer.

7. The hose of claim 1, wherein the generally elastomeric material is selected from a group consisting of: ethylene propylene diene monomer rubber, natural rubber and styrene butadiene rubber.

8. The hose of claim 1, wherein the fabric layers include a plurality of polyester inserts.

9. An elastically deformable hose for a peristaltic pump, the hose comprising:
a generally tubular member capable of transporting a medium, the tubular member formed from a group consisting of: ultra high molecular weight polyethylene, fluoropolymer elastomer, polychloroprene and nitrile butadiene rubber;
a plurality of fabric layers generally positioned over the tubular member; and
an ethylene propylene diene monomer rubber outer layer generally positioned over the fabric layers, wherein the ethylene propylene diene monomer rubber outer layer includes a generally smooth outer surface.

10. The hose of claim 9, wherein the tubular member is formed from ultra high molecular weight polyethylene.

11. The hose of claim 9, wherein the tubular member is formed from fluoropolymer elastomer.

12. The hose of claim 11, wherein the outer surface is formed by wrapping the ethylene propylene diene monomer rubber outer layer with a plastic film, autoclaving the tubular member, fabric layers, elastomeric outer layer, and plastic film combination, and removing the plastic film.

13. The hose of claim 12, wherein the plastic firm includes a Mylar film.

14. A hose for a peristaltic pump for industrial use, the hose comprising:
an elastically deformable generally tubular member capable of transporting a medium;
a plurality of fabric layers positioned over the tubular member; and
a generally elastomeric outer layer positioned over the fabric layers, the elastomeric layer including a generally smooth outer surface, wherein the outer surface is formed by wrapping the elastomeric layer with a plastic film, autoclaving the tubular member, fabric layers, elastomeric outer layer, and plastic film combination, and removing the plastic film.

15. The hose of claim 14, wherein tubular member is formed from an ultra high molecular weight polyethylene.

16. The hose of claim 14, wherein the generally tubular member is formed from a group consisting of: fluoropolymer elastomer, polychloroprene and nitrile butadiene rubber.

17. The hose of claim 16, wherein the rubber material is a fluoropolymer elastomer.

18. The hose of claim 14, wherein the generally elastomeric material comprises ethylene propylene diene monomer rubber.

19. The hose of claim 14, wherein the plastic firm includes a Mylar film.

20. The hose of claim 14, wherein the medium is selected from a group consisting of: bleach, corrosive slurry, and abrasive slurry, acids, alkali, colorants, and inks.

21. A method of forming a hose for a peristaltic pump, the method comprising:
forming a generally tubular member capable of transporting a medium;
placing a plurality of fabric layers over the tubular member;
positioning an elastomeric outer layer generally over the fabric layers;
wrapping the elastomeric outer layer with a film of at least one of plastic and polyester; and
vulcanizing the tubular member, fabric layers elastomeric outer layer, and film combination, wherein the elastomeric outer layer is generally smooth.

22. The method of claim 21 further comprising the step of removing the film.

23. The method of claim 21, wherein the generally tubular member is formed from an ultra high molecular weight polyethylene.

24. The method of claim 21, wherein the generally tubular member is formed from a group consisting of: fluoropolymer elastomer, polychloroprene and nitrile butadiene rubber.

25. The method of claim 24, wherein the tubular member is formed from fluoropolymer elastomer.

26. The method of claim 21, wherein the plastic film comprises a Mylar film.

27. The method of claim 21, wherein the step of placing a plurality of fabric layers over the tubular member includes wrapping a four-ply polyester insert around the tubular member.

28. The method of claim 21, wherein the step of placing a plurality of fabric layers over the tubular member includes wrapping a polyester insert around the tubular member four times.

29. A method of forming a hose for a peristaltic pump, the method comprising:
forming a generally tubular member including a material selected from a group consisting of: fluoropolymer elastomer, polychloroprene, nitrile butadiene rubber, and ultra high molecular weight polyethylene, wherein the tubular member is capable of transporting a medium;
placing a plurality of fabric layers over the tubular member;
positioning an ethylene propylene diene monomer rubber outer layer generally over the fabric layers; and
forming a generally smooth outer surface on the outer layer using a plastic film.

30. The method of claim 29 further comprising the step of vulcanizing the tubular member, fabric layers, elastomeric outer layer combination, and plastic film.

31. The method of claim 30 further comprising the step of removing the plastic film.

32. The method of claim 29, wherein the plastic film comprises a Mylar film.

33. The method of claim 29, wherein the tubular member is formed from a group consisting of: fluoropolymer elastomer and ultra high molecular weight polyethylene.

34. A method of forming a hose for a peristaltic pump, the method comprising:
forming a generally tubular member formed from a group consisting of:
fluoropolymer elastomer, polychloroprene, nitrile butadiene rubber, and ultra high molecular weight polyethylene, wherein the tubular member is capable of transporting a medium;
placing a plurality of fabric layers over the tubular member;
positioning an ethylene propylene diene monomer rubber outer layer over the fabric layers;
wrapping the outer layer with a Mylar film;
vulcanizing the tubular member, fabric layers elastomeric outer layer, and Mylar film combination; and
removing the Mylar film from the tubular member, fabric layers, and elastomeric outer layer combination, forming the elastomeric outer layer with a generally smooth outer surface.

35. The method of claim 34, wherein the medium comprises a solid.
